(19) United States
(12) Patent Application Publication
(10) Pub. No.: US 2025/0315157 A1
(43) Pub. Date: Oct. 9, 2025

(54) Interactive Playback Control and Dynamic Pacing in Pre-Recorded Digital Conversations

(71) Applicant: Jason Matthew Roos, Irvine, CA (US)

(72) Inventor: Jason Matthew Roos, Irvine, CA (US)

(21) Appl. No.: 18/814,622

(22) Filed: Aug. 26, 2024

Related U.S. Application Data
(63) Continuation-in-part of application No. 18/628,854, filed on Apr. 8, 2024.

(51) Int. Cl. G06F 3/04847

(52) U.S. Cl. CPC G06F 3/04847

(57) ABSTRACT

The present disclosure relates to a computer-implemented method for managing the playback of pre-recorded digital conversations. This method is executed between one or more servers and a user device and involves sequentially presenting a series of message segments on the user device, with each segment separated by a time interval. The method allows users to interact with the playback by cutting short the current time interval and advancing to the next message segment, pausing the playback, and resuming playback with an automatic advancement to the next segment. This approach enhances user control and engagement during the playback of pre-recorded conversations.

### CROSS-REFERENCE TO RELATED APPLICATIONS

This application is a continuation-in-part application of U.S. Non-Provisional application Ser. No. 18/628,854, filed on 8 Apr. 2024. The entirety of the aforementioned non-provisional application is hereby incorporated by reference for all purposes.

### FIELD OF INVENTION

The present invention relates to digital communication technologies, specifically to methods and systems for interactive control and dynamic pacing of pre-recorded textual and auditory conversations.

### BACKGROUND

In the realm of digital communication, the quest to replicate the nuances of live interactions within pre-recorded conversations presents considerable challenges. Traditional systems for replaying such discussions, whether textual or auditory, typically adhere to a fixed-speed playback methodology. This approach, while functional, overlooks the dynamic nature of human communication, often leading to a user experience that feels unnatural and disconnected. In particular, these systems fail to account for the varying comprehension speeds and preferences of individual users, leading to a one-size-fits-all solution that can neither adapt to the context within a conversation nor cater to the specific needs of the user. Furthermore, existing methods tend to treat all messages with uniform importance, disregarding the potential to optimize message timing to enhance realism and engagement.

Another significant limitation of current technologies is their inability to effectively manage system notifications and conversational messages in a way that maintains the natural flow of a conversation. Notifications such as “John Doe has joined the chat” are often replayed without consideration for their impact on the conversation's rhythm, disrupting the user's experience. Moreover, the rigid approach to message timing does not allow for adjustments based on the relationship between messages or the context of the conversation, missing opportunities to create a more engaging and comprehensible interaction.

Additionally, while some advancements have been made in augmenting live interactions, these solutions do not address the unique challenges presented by pre-recorded conversations. They fail to remove superfluous delays or strategically introduce pauses that could emulate the rhythm of live interaction, thereby improving both comprehension and engagement. The absence of a method to classify the nature of message transitions further exacerbates these issues, leading to a playback experience that lacks the nuanced understanding of human communication dynamics.

Furthermore, current systems do not adequately accommodate the need for user interaction during playback, such as the ability to manually advance or pause the conversation. Users who read quickly may become frustrated by the inability to skip forward, while those who prefer a slower pace may find it difficult to control the flow of the conversation effectively. This lack of flexibility can result in a disengaged or inefficient user experience, particularly when the system fails to align with the user's natural reading or listening pace.

These challenges underscore the need for a more advanced method that can dynamically adjust to the intricacies of pre-recorded interactions, offering a solution that is both more engaging and more attuned to the user's needs. The limitations of traditional fixed-speed playback methods, the lack of context-sensitive message handling, and the absence of interactive controls highlight the need for an improved approach that can better replicate the fluidity and responsiveness of live communication.

It is within this context that the present invention is provided.

### SUMMARY

The present invention provides a computer-implemented method for managing the playback of pre-recorded digital conversations. This method is executed between one or more servers and a user device. The method involves receiving a pre-recorded digital conversation comprising a sequence of message segments. These segments are sequentially presented on the user device, with each subsequent message segment being separated by a time interval. The method allows for user interaction, where a first type of user interaction cuts short the current time interval and advances the playback to a subsequent message segment. A second type of user interaction pauses the playback, and a third type of user interaction resumes the paused playback while simultaneously cutting short the current time interval to advance to the next message segment.

In some embodiments, the method includes imposing a restriction that prevents cutting short the current time interval until a predetermined amount of time has elapsed since the segment was presented. This restriction ensures that the user has sufficient time to engage with the content before advancing.

In further embodiments, the method provides visual indicators to inform the user when cutting short the current time interval is prohibited and when it is allowed. This feature enhances the user experience by clearly communicating the status of the playback control.

In yet further embodiments, the visual indicators may include at least one of a transient animation, a static message, or an icon. These options provide flexibility in how the system communicates playback status to the user.

In some embodiments, the method includes providing an option to disable restrictions on cutting short the current time interval for verified users or advanced-level users. This feature allows more experienced users to have greater control over the playback experience.

In further embodiments, the first, second, and third user interaction types each include pressing a designated area of the user device screen. This approach simplifies the user interface and ensures that controls are easily accessible.

In yet further embodiments, the designated areas on the screen are assigned to different functions, with one area dedicated to pausing and another to cutting short the current time interval and advancing the playback. This separation of controls reduces the likelihood of user errors during interaction.

In some embodiments, the method further includes dynamically adjusting the size and location of the designated area segments based on the user's actions and screen orientation. This dynamic adjustment improves the usability of the playback controls, particularly on mobile devices.

In further embodiments, the method comprises receiving a set of user data for a first user, which includes reading or listening preferences. For each message segment in the sequence, the method determines a comprehension time required for the user to digest the content of the segment. This determination is based on the user data, enabling the system to tailor the playback pacing to individual user needs.

In yet further embodiments, the user data may also include demographic data of the first user, and the determination of the comprehension time for each segment is further refined based on this demographic data. This allows for even more personalized playback pacing.

In some embodiments, the method imposes a restriction that prevents cutting short the current time interval until a predetermined amount of time, potentially a percentage of the calculated dwell time, has elapsed since the segment was presented. This ensures that the timing remains consistent with the user's comprehension abilities.

In further embodiments, the method includes displaying a typing indicator during the dwell time of a segment. This feature adds a layer of realism to the playback by simulating live conversation dynamics.

In yet further embodiments, the playback speed of the conversation may be adjusted based on the user's reading or listening speed preferences included in the user data. This adjustment ensures that the playback aligns with the user's natural pace, enhancing comprehension and engagement.

In some embodiments, the classification of segments includes identifying segments as either system segments or user segments. This classification allows the system to handle different types of content appropriately, maintaining the flow of the conversation.

In further embodiments, the method includes adjusting the calculated dwell time for segments classified as system segments to maintain the natural flow of the conversation. This adjustment is constrained within predefined minimum and/or maximum limits to ensure consistency.

In such embodiments, sub-classifying user messages based on the target recipient allows for dwell times to be calculated with even greater precision. This feature enables the system to adjust playback speed more effectively, creating a playback experience that more closely mimics the pace of live interactions.

In other such embodiments, the method further comprises the step of sub-classifying user messages based on whether the sender of the message is the same as the sender of the next message. In such examples it may be the case that the dwell time for messages from the same sender as the next message is reduced or eliminated to replicate the rapid succession typical of live interactions. Furthermore, the dwell time for messages from the same sender as the previous message may be extended to compensate for the reduced dwell time of the previous message.

### BRIEF DESCRIPTION OF THE DRAWINGS

Various embodiments of the invention are disclosed in the following detailed description and accompanying drawings.

FIG. 1 illustrates an example of a computer-implemented method for managing playback of pre-recorded digital conversations as experienced by a verified user.

FIG. 2A illustrates an example user interface showing an overlay that appears when the user taps to pause the playback.

FIG. 2B illustrates an example user interface showing an overlay that appears when the user taps to skip ahead in the conversation.

FIG. 3A illustrates an example user interface for a paused chat replay, showing visual cues and interactive elements to guide the user in resuming playback.

FIG. 3B illustrates an example user interface for a chat replay, indicating that the skip ahead action is currently prohibited due to the minimum dwell time not having elapsed.

FIG. 4 illustrates an example system architecture, detailing the interaction between a user, their device, and the servers through a cloud network architecture.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, “user device” refers to any electronic device capable of receiving, processing, and displaying messages as part of a pre-recorded conversation. The user device may be a smartphone, tablet, laptop, desktop computer, smartwatch, or any other type of computing device with a display and the capability to interact with one or more servers. The user device is configured to execute a dedicated application or web-based interface that facilitates the presentation of messages in accordance with the calculated dwell times.

The term “pre-recorded digital conversation” refers to any sequence of messages, whether textual or auditory, that has been previously recorded and stored for later playback. This includes, but is not limited to, chat logs, email threads, voice messages, and other forms of digital communication. In one example implementation, the pre-recorded digital conversation may be a series of chat messages stored on a server and retrieved for playback on a user's mobile device, where each message is presented sequentially according to the system's playback methodology.

The term “message segment” refers to an individual unit of communication within the pre-recorded digital conversation. This can include a single message, a portion of a message, or any other discrete communication element that is presented to the user during playback. In one example implementation, a message segment may be a single text message sent by a participant in a chat or a portion of an email thread displayed on a user's smartphone screen.

The term “time interval” refers to the duration between the presentation of one message segment and the subsequent message segment within the playback sequence. This interval is determined by the system based on various factors such as user preferences, comprehension time, and context. In one example implementation, the time interval is dynamically adjusted by the system to match the user's reading speed, ensuring that each message segment is displayed for an optimal period before the next one is shown.

The term “user interaction” refers to any input provided by the user that influences the playback of the pre-recorded digital conversation. This can include, but is not limited to, tapping, clicking, swiping, or pressing a button on the user device. In one example implementation, a user interaction may involve pressing a designated area of a tablet screen to pause the playback or tapping another area to skip forward to the next message segment.

“User data,” as described herein, encompasses any information related to the first user that can influence the playback pacing of a pre-recorded conversation. This includes, but is not limited to, reading and listening preferences, demographic information such as age, education level, language proficiency, and any other data that can affect comprehension speed. User data may be explicitly provided by the user or inferred from user interactions and behaviors within the application or service. Additionally, the mere selection of a conversation by the user is considered part of “user data,” as the nature of the selected conversation itself may imply the user's reading preferences and/or demographics, particularly in scenarios involving anonymous users who do not have an account for saving preferences. For these users, the app relies on their conversation selection to gauge potential demographic details, given that the target audience may be indicated on the event card associated with the conversation. Reading preferences are explicitly indicated when the user, once engaged in a chat, selects “Change Speed” from the in-chat menu. This action allows the user to adjust the speed of the playback according to their preference, providing a direct input on their desired pacing for the conversation playback.

“Playback,” as used herein, refers to the process of presenting pre-recorded conversations to a user through the user device. These conversations can range from those that occurred historically, spanning back days, months, or even years, to those that transpired mere minutes or milliseconds prior to being played back. The term encompasses the playback of both manually recorded conversations and auto-generated conversations that are created dynamically by the system in response to user interactions or predefined criteria. The playback process is designed to simulate the flow and dynamics of a live conversation, adjusting the timing and sequence of message presentation based on user preferences and the calculated pacing parameters to enhance the user's engagement and understanding of the content. This broad interpretation of “playback” allows for a wide range of applications, from reviewing past interactions for information retrieval to experiencing auto-generated dialogues that provide real-time information or entertainment.

The term “comprehension time” refers to the estimated time required for a user to understand the content of a message. This estimation is based on a combination of user data and potentially other contextual factors, such as the complexity of the message content, the format of the message (textual or auditory), and the historical interaction patterns of the user. Comprehension time is calculated by the one or more servers using algorithms that may incorporate machine learning techniques to adapt and improve over time based on user feedback and engagement metrics.

“Dwell time,” as used herein, represents the duration for which a message is presented to the user before transitioning to the next message in the sequence. The calculation of dwell time takes into account the comprehension time, the classification of the message sender, and the nature of the transition between messages (e.g., from user to system, system to user, user to the same user, or user to a different user). Dwell time is dynamically adjusted to simulate the natural pacing of live conversations, enhancing the realism and user engagement with the pre-recorded conversation.

An example implementation of this invention could involve a server infrastructure comprising cloud-based services that process user data and pre-recorded conversations to calculate dwell times for each message. The servers could use advanced analytics and machine learning algorithms to refine the comprehension time estimations based on accumulating user interaction data. The user device, running a dedicated application, receives timing instructions from the servers and presents the messages with their calculated dwell times, adjusting playback in real time based on user interactions, such as pausing or resuming the conversation.

### Description of Drawings

The present invention relates to methods and systems for managing the playback of pre-recorded digital conversations, offering a more interactive and adaptable user experience. Unlike traditional playback systems, which often rely on fixed-speed methodologies and fail to account for individual user needs, this invention introduces a dynamic approach to conversation playback. The method allows users to interact with the playback process through actions such as skipping forward, pausing, and resuming with advanced timing controls.

Traditional systems typically treat all message segments uniformly, without consideration for the varying comprehension speeds of individual users or the context of the conversation. This often leads to a disconnected and unnatural user experience, where the timing of messages does not align with the user's natural reading or listening pace. Additionally, current systems are generally rigid, offering little flexibility in how users can control the playback, which can result in frustration, especially for users who wish to either quickly skim through or take their time with the conversation.

The present invention overcomes these limitations by providing a method that dynamically adjusts playback timing based on user interactions and preferences. It allows users to cut short the current time interval and advance to the next message segment with a simple interaction, pause the playback when needed, and resume it with automatic advancement to the next segment, ensuring that the conversation flow is always under the user's control. This adaptability ensures that the playback experience is more natural and engaging, aligning closely with how users would interact in real-time communication.

Furthermore, the invention introduces mechanisms for managing the presentation of message segments in a way that considers the importance and context of each segment by incorporating restrictions that prevent skipping forward until a certain amount of time has elapsed, and by providing visual indicators to inform users of when actions are permitted. These features also help to deter automated content scraping and ensure that users remain genuinely engaged with the conversation.

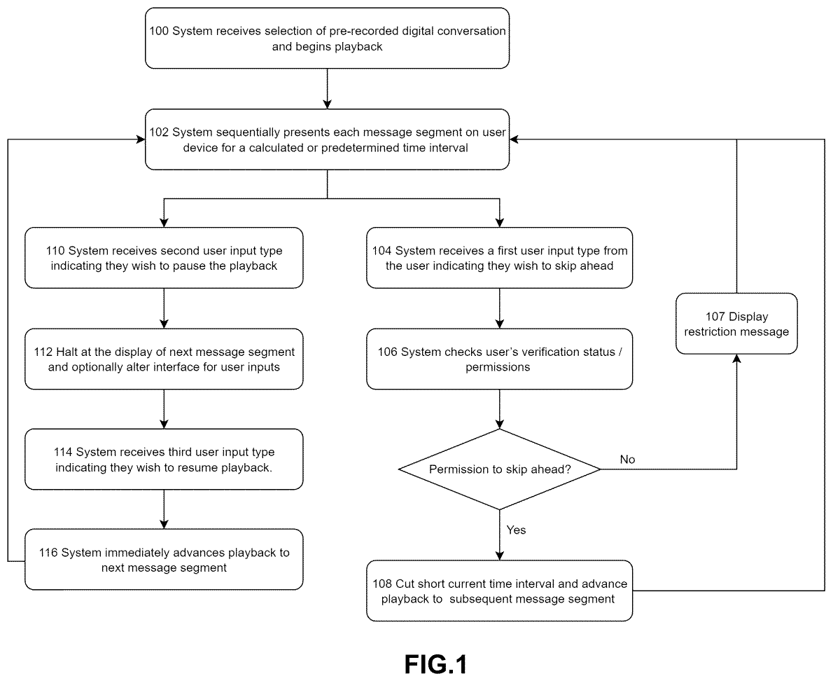

FIG. 1 illustrates a computer-implemented method for managing playback of pre-recorded digital conversations as experienced by a verified user. The method is executed between one or more servers and a user device, such as a smartphone or tablet.

The process begins when the user accesses the system and selects a pre-recorded digital conversation for playback. The system receives the pre-recorded digital conversation, which includes a sequence of message segments from multiple participants, and initiates the playback sequence 100.

The system then sequentially presents each message segment on the user device, displaying each segment for a predetermined time interval based on the user's preferences or system defaults 102. As the conversation progresses, each subsequent message segment is displayed on the user device, with the display of each segment being separated by a time interval (which may in some examples be calculated to match the user's reading or listening speed).

During playback, the user decides to skip ahead to the next message segment. They may do so by applying a first user input type 104, which may involve pressing a designated area of the interface (the right half, for example) or may involve pressing a standard user interface control button.

The system checks the user's verification status or permissions 106. If the user has appropriate permissions/verification status, the system confirms that they are allowed to bypass the minimum time interval restriction, and immediately cuts short the current time interval, advancing the playback to the subsequent message segment 108, then proceeds as normal. On the other hand, if the user does not have appropriate status/permissions, a message is displayed 107 indicating this and the current time interval is not cut short.

Assuming appropriate permissions, the user may repeat this skip ahead action as many times as they like, quickly moving through multiple message segments. Each time, the system acknowledges the skip ahead request, verifies the user's ability to skip without delay, and promptly advances to the next message segment in the sequence.

At a certain point, the user may decide to pause the playback. The user initiates a pause action via a second user input type, such as tapping an alternate designated area of the interface (the left half, for example) or a standard pause control button 110. The system responds by halting the display of the next message segment and storing the current state of the conversation 112. This pause allows the user to temporarily stop the playback and take a break, ensuring that the conversation remains at the exact point where they left off. While the playback is in a pause state, the entire screen may become a designated area for inputting the third user input type for resuming the conversation.

Thus, when the user is ready to continue, they resume the playback by tapping anywhere on the screen to apply the third user input type 114. The system, recognizing the resume command, checks whether there is any remaining dwell time for the current segment. Since the system assumes they have already read the segment, the remaining dwell time is cut short, and the playback advances immediately to the next message segment 116. The user device continues the sequential presentation of the conversation from this new point.

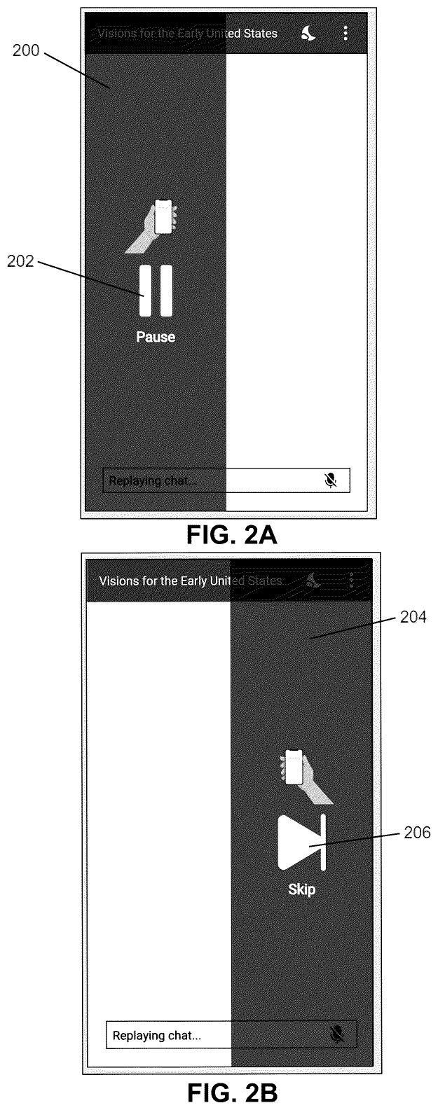

FIGS. 2A and 2B illustrate the user interface of a chat replay system on a mobile or tablet device, showing how the interface may respond to user interactions by displaying overlays that indicate the current playback state, such as pausing or skipping ahead, without cluttering the interface with permanent control buttons.

It is noted that the overlays are illustrative and may not be visible at all during an actual playback implementation.

In FIG. 2A, the interface is shown with an overlay 200 that appears when the user taps the left side of the screen to pause the playback. The left half of the screen is shaded to indicate the area that is interactive for pausing. A large pause icon 202 is prominently displayed along with the label “Pause”. The right side of the screen remains unshaded, reinforcing the separation of control areas and ensuring that the user can easily distinguish between different interaction zones.

In FIG. 2B, the interface is shown with a similar overlay 204 that appears when the user taps the right side of the screen to skip ahead in the conversation. Here, the right half of the screen is shaded to indicate the area designated for the skip function. A skip icon 206, represented by a forward arrow, is prominently displayed along with the label “Skip”. This overlay informs the user that the skip ahead function has been activated, allowing them to move quickly to the next message segment in the conversation. The left side of the screen remains unshaded, maintaining the distinction between the pause and skip control zones.

The overlays may be designed to appear temporarily when the user interacts with the respective control areas of the screen. These overlays serve a dual purpose: they guide the user when they first access the chat replay feature, and they confirm the user's actions during playback by momentarily displaying the relevant control information. This design choice enhances the user experience by keeping the interface clean and free of clutter, while still providing clear feedback on the playback state.

The use of large, easily recognizable icons and clear labels ensures that users can quickly understand the functions available to them, reducing the learning curve associated with using the chat replay system.

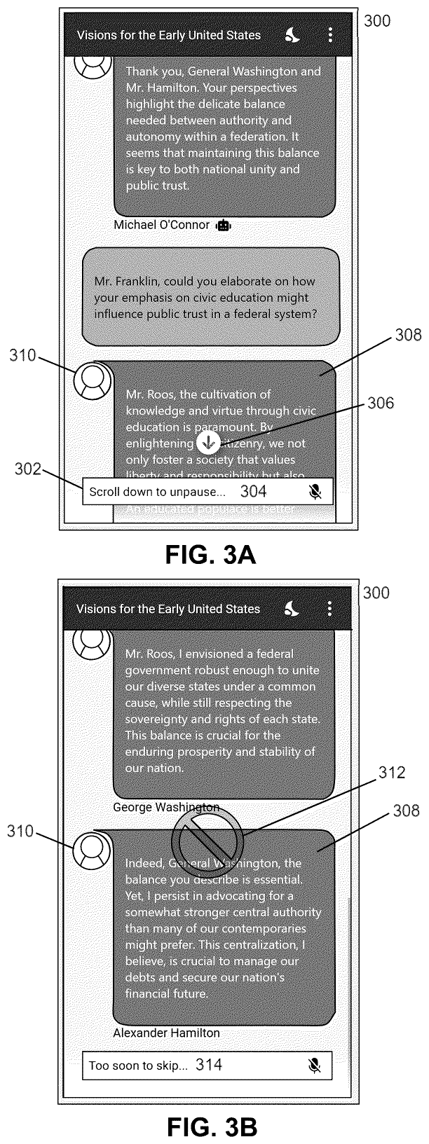

FIG. 3A illustrates a user interface 300 for a paused chat replay on a mobile or tablet device, where the user has scrolled up within the conversation, triggering an automatic pause. The figure demonstrates some of the intelligent chat control features that may be implemented alongside the pause and skip ahead features of the invention.

In the paused state, the interface prominently displays a bar 302 at the bottom of the screen with the text “Scroll down to unpause . . . ” 304. This message instructs the user on how to resume playback, clearly indicating that scrolling down will continue the conversation from where it was paused.

Accompanying the message is a down arrow icon 306, which serves as a visual cue, reinforcing the instruction to scroll down.

The interface also allows for additional flexibility in resuming playback. While the instruction suggests scrolling down to unpause, the entire screen may, in other examples, be interactive in this paused state. The user may click or tap anywhere on the screen to unpause the conversation, regardless of the area they select. This includes the areas normally designated for “skip ahead” actions, which are temporarily inactive while the playback is paused, ensuring that a tap anywhere on the screen will result in unpausing rather than skipping ahead.

The chat messages may have a color-coded appearance, with each participant's message segment 308 easily distinguishable by its unique color and accompanied by the participant's name and avatar 310. The content displayed in the main chat area includes both previous and current messages, reflecting the user's position in the conversation when they scrolled up.

FIG. 3B illustrates a similar user interface 300 for a chat replay on a mobile or tablet device, specifically focusing on the interaction when the system prevents the user from skip ahead actions in the conversation until after the minimum dwell time has elapsed.

In FIG. 3B, the interface displays a “Prohibited” indicator 312 at the center of the screen, signifying that the skip ahead action is currently restricted. The prohibited icon overlays the chat messages 308 indicating to the user that skipping ahead is not allowed at this time. This restriction is usually due to the minimum dwell time for the current message segment not yet being met and the user not being a verified user.

Below the prohibited icon, a feedback message 314 at the bottom of the screen reads “Too soon to skip . . . ,” reinforcing the restriction.

The above-described skip ahead, pause, resume functionalities, and the related user interface indicators, are particularly useful in the use case of replaying Al-based chatbot conversations having dynamic timing features as described in the applicant's co-pending U.S. application Ser. No. 18/628,854, the contents of which are herein incorporated by reference.

The present invention thus further relates to a computer-implemented method designed to enhance the playback of pre-recorded conversations by allowing users to interactively manage the pacing of the playback through skip ahead and pause functions, in addition to adjusting pacing based on user data and the context of the conversation. This method involves a collaborative process between servers and a user device, where the servers analyze user preferences, including reading and listening habits, and apply these preferences to modify the playback speed and enable interactive control over the sequence of messages within a conversation. This approach ensures that each message is presented for an optimal duration, known as dwell time, which is calculated to accommodate the user's comprehension capabilities and preferences while also providing the user with control over the pacing through skip and pause actions.

The method begins with the collection of user data, which informs the servers about the user's reading or listening preferences. Following this, the servers receive a pre-recorded conversation that includes a series of messages from multiple entities. Each message is then analyzed to determine the required comprehension time for the user, taking into account the user's data. The method further allows the user to skip ahead to subsequent messages or pause the playback, offering a more dynamic and engaging conversation experience that addresses the limitations of traditional fixed-speed playback methods by introducing a level of personalization, adaptability, and user interactivity.

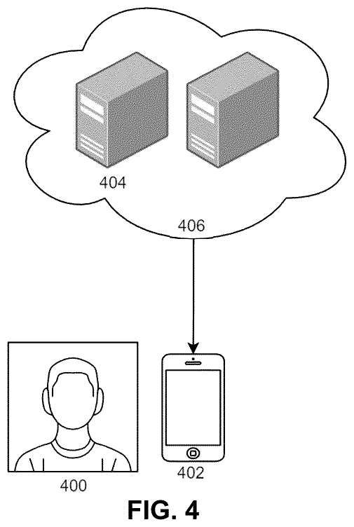

FIG. 4 illustrates an example implementation of the system architecture for adjusting the playback pacing of pre-recorded conversations according to user preferences, as well as enabling user-controlled interactions such as skip ahead and pause functions.

A user 400 is shown, who interacts with the system via a user device 402. The user device 402 can be any personal computing device capable of connecting to the internet and displaying messages, such as a smartphone, tablet, laptop, or desktop computer. The device is equipped with a dedicated application or web-based interface that allows the user to access and engage with pre-recorded conversations. This interface is designed to receive user input, including reading or listening preferences, potentially demographic information, and any indications of the user's verification status or level, which is critical for personalizing the playback pacing of conversations and managing the interactive functions such as skipping ahead or pausing the playback.

The user device 402 communicates with a set of servers 404, which are responsible for executing the core functionalities of the method. These functionalities include receiving user data, processing pre-recorded conversations, determining comprehension times for messages, classifying messages, and calculating dwell times. The servers operate over a cloud network architecture 406, which provides the necessary infrastructure to support these operations. While the servers 404 execute these core functionalities, client software on the user device 402 manages user interactions related to skipping ahead and pausing playback. This client-side management ensures immediate responsiveness to user commands. The cloud network architecture 406 can incorporate data analytics and monitoring tools to track system performance and user engagement metrics, including how often users engage with skip ahead or pause functions as reported by the client

The communication between the user device 402 and the servers 404 is facilitated by a secure and efficient data transmission protocol, such as HTTPS, utilizing RESTful APIs or similar technologies for exchanging data in a structured format like JSON or XML. This communication framework supports real-time interaction by enabling the user device 402 to manage playback controls locally, such as skipping ahead or pausing the conversation, ensuring immediate responsiveness to user commands. The server 404, while responsible for executing core functionalities like processing pre-recorded conversations and determining comprehension times, operates in a supportive role by delivering necessary data and updates to the client software.

### Network Components

A server as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner, as described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

### Conclusion

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the computer-implemented method of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method for managing playback of pre-recorded digital conversations, the method executed between one or more servers and a user device, comprising the steps of:
receiving a pre-recorded digital conversation comprising a playback of a sequence of message segments;
sequentially presenting the sequence of message segments on the user device, the display of each subsequent message segment being separated by a time interval;
in response to a first user interaction type, cutting short a current time interval and advancing the playback of the displayed sequence to a subsequent message segment;
in response to a second user interaction type, pausing the playback; and
in response to a third user interaction type, resuming the paused playback and cutting short the current time interval and advancing the playback of the displayed sequence to a subsequent message segment.

2. The method of claim 1, further comprising imposing a restriction that prevents cutting short the current time interval until a predetermined amount of time has elapsed since the segment was presented.

3. The method of claim 2, further comprising providing visual indicators to inform the user when cutting short the current time interval is prohibited and when it is allowed.

4. The method of claim 3, wherein the visual indicators include at least one of a transient animation, a static message, or an icon.

5. The method of claim 2, further comprising providing an option to disable restrictions on cutting short the current time interval for verified users or advanced-level users.

6. The method of claim 1, wherein the first user interaction type, second user interaction type, and third user interaction type, each include pressing a designated area of a screen of the user device.

7. The method of claim 6, wherein the designated areas are assigned to different functions, with one area for pausing and another area for cutting short the current time interval and advancing the playback.

8. The method of claim 7, further comprising dynamically adjusting the designated area segments based on the user's actions and screen orientation.

9. The method of claim 1, further comprising:
receiving a set of user data for a first user, the user data including at least a set of reading or listening preferences;
for each message segment in the sequence, determining a comprehension time required for the first user to digest the content of the segment, the determination based on the received set of user data;
for each message segment in the sequence, classifying the segment based on the identity of the entity that sent the segment;
calculating, for each message segment in the sequence, a dwell time, the dwell time representing the length of time for which the segment is to be presented to the first user before presenting the next segment in the sequence, the dwell time being used as the time interval for sequentially presenting the message segments.

10. The method of claim 9, wherein the user data further includes demographic data of the first user, and the determination of the comprehension time for each segment is further based on the demographic data.

11. The method of claim 9, further comprising imposing a restriction that prevents cutting short the current time interval until a predetermined amount of time has elapsed since the segment was presented.

12. The method of claim 11, wherein the predetermined amount of time is a percentage of the calculated dwell time for the segment.

13. The method of claim 9, further comprising displaying a typing indicator during the dwell time of a segment.

14. The method of claim 9, further comprising adjusting the playback speed of the conversation based on the user's reading or listening speed preferences included in the user data.

15. The method of claim 9, wherein the classification of segments includes identifying segments as either system segments or user segments.

16. The method of claim 15, further comprising adjusting the calculated dwell time for segments classified as system segments within the pre-recorded conversation to maintain the natural flow of the conversation, the adjustment constrained within predefined minimum and/or maximum limits.

17. The method of claim 15, wherein the dwell time for segments directed to the same user as the preceding segment is reduced or eliminated to replicate the rapid succession typical of live interactions.

18. The method of claim 15, wherein the dwell time for messages from the same sender as the next message is reduced or eliminated to replicate the rapid succession typical of live interactions.

19. The method of claim 18, wherein the dwell time for messages from the same sender as the previous message is extended to compensate for the reduced dwell time of the previous message.
